(19) United States
(12) Patent Application Publication
(10) Pub. No.: US 2004/0226613 A1
(43) Pub. Date: Nov. 18, 2004

(54) Relief valve mechanism for an oil pump

(76) Inventor: Hisashi Ono, Toyota-shi (JP)

Correspondence Address: REED SMITH LLP, Suite 1400, 3110 Fairview Park Drive, Falls Church, VA, 22042, US

(21) Appl. No.: 10/765,194

(22) Filed: Jan. 28, 2004

(30) Foreign Application Priority Data
Jan. 28, 2003 (JP) 2003-019173

(51) Int. Cl. F16K 17/06

(52) U.S. Cl. 137/468

(57) ABSTRACT

A relief valve mechanism for an oil pump includes a body having a first hole, a spring housed in the body adapted to apply biasing force to a relief valve in response to contraction of the spring, a first opening connected to the first hole of the body, a relief valve adapted to close the first opening in response to the biasing force of the spring and adapted to open the first opening against the biasing force in response to pressure of fluid from the oil pump applied to one end of the valve means and means for sensing a temperature at a the spring at a side of a valve or at an opposite side to the valve. The means for sensing the temperature is altered in an axial direction of the spring.

### CROSS REFERENCE TO RELATED APPLICATIONS

This application is based on and claims priority under 35 U.S.C. § 119 with respect to Japanese Patent Application 2003-019173, filed on Jan. 28, 2003, the entire content of which is incorporated herein by reference.

### FIELD OF THE INVENTION

This invention generally relates to a relief valve mechanism for an oil pump.

### BACKGROUND

Recent developments have lead to an internal combustion engine which is provided with, for example a variable valve timing control system, and oil jet for cooling an engine piston, a balancer for the engine, or the like. The variable valve timing control system controls an opening/closing time of a valve of an engine. This type of engine may have constrained oil to be increasingly consumed. In the meantime, this type of engine is operated in a wide temperature range such that an oil pressure mechanism for the engine has been designed to ensure necessary oil pressure at an upper threshold oil temperature level such as 130 degrees Celsius. However, the engine is generally used at an operating temperature such as 80 degrees Celsius. The consumed oil amount, i.e., the oil pressure may be hence unnecessarily increased around the normal operating temperature. In this case, following matters to be reconsidered may occur: unnecessary increase of driving force for driving an oil pump; unnecessary increase of engine friction torque; excessive consuming of vehicle fuel, et cetra.

There arc some references that disclose description in order to solve the above-described matters. A relief valve mechanism is disclosed in Japanese Utility Model Patent Publication No. 1985-99370. According to the reference, the relief valve mechanism is provided with a valve housing having a valve opening, a main spool housed in the valve opening, and a spring slidably pushing the main spool in a direction for closing an oil pressure guiding portion and a drain portion. The relief valve mechanism is further provided with a sub spool and another spring that is made of shape-memory alloy. The sub spool is slidably housed in the main spool. The shape-memory alloy made spring always pushes the sub spool in a direction for closing a passage that is defined at the main spool for supplying the oil pressure to one end of the sub spool.

A temperature sensing type oil pressure adjusting valve is disclosed in Japanese Utility Model Patent Publication No. 1990-44182. According to the reference, a valve body is designed to be seated on a valve seat in an oil pressure circuit by use of a shape-memory material. Further, an oil pump apparatus is disclosed in Japanese Patent Laid-Open Publication No. 1997-256969 which is described in U.S. Patent Publication No. 5,759,013. According to the reference, a suction port, an intermediate port, and a discharging port are opened and closed by controlling a valve body by a proportional electromagnetic control means.

However, the shape-memory alloy made spring for the oil pressure adjusting valve according to the first two references has less allowable stress than a normal spring does. Therefore, when a valve opening pressure is designed to be at a allowable stress or less than that, a diameter of a spring wire, a coil diameter, and a free length of the spring need to be designed at a relatively long dimension. In this case, the relief valve mechanism itself may be upsized. Further, this type of shape-memory alloy made spring demands a high manufacturing cost. In the meantime, since the oil pressure adjusting valve according to the third reference includes the proportional electromagnetic control means, the oil pressure adjusting valve may demand a high manufacturing cost and a unnecessary large structure.

A need thus exists for providing an improved oil pump provided with a relief valve mechanism manufactured with a compact structure at a relatively low manufacturing cost, that is capable of adjusting engine oil pressure.

### SUMMARY OF THE INVENTION

According to an aspect of the present invention, a relief valve mechanism for an oil pump includes a body having a first hole, a spring housed in the body and adapted to apply biasing force to a valve in response to contraction of the spring, a first opening connected to the first hole of the body, and the valve adapted to close the first opening in response to the biasing force of the spring and adapted to open the first opening against the biasing force in response to pressure of fluid from the oil pump applied to one end of the valve. The relief valve mechanism further includes means for sensing a temperature positioned at the spring at a side of the valve or at an opposite side to the valve. It is preferable that the means for sensing the temperature is altered in an axial direction of the spring.

It is preferable that the means for sensing the temperature includes a cylindrical member with at least a bottom, a retainer slidably positioned in a second hole of the cylindrical member, and a thermally adapted material enclosed by the retainer and the second hole.

It is further preferable that the cylindrical member is a plug adjusted to close the first hole and to avoid dropping of the valve. Therefore, fewer components are required to construct the relief valve mechanism.

### BRIEF DESCRIPTION OF THE DRAWING FIGURES

The foregoing and additional features and characteristics of the present invention will become more apparent from the following detailed description considered with reference to the accompanying drawing figures, wherein:

FIG. 1 is a cross sectional view illustrating a relief valve mechanism for an oil pump according to an embodiment of the present invention;

FIG. 2 is the other cross sectional view illustrating the relief valve mechanism for the oil pump according to the embodiment of the present invention;

FIG. 3 is a diagram explaining an oil pressure characteristic of an engine provided with the relief valve mechanism for the oil pump according to the embodiment of the present invention; and

FIG. 4 is a cross sectional view illustrating a relief valve mechanism for a conventional oil pump.

### DETAILED DESCRIPTION

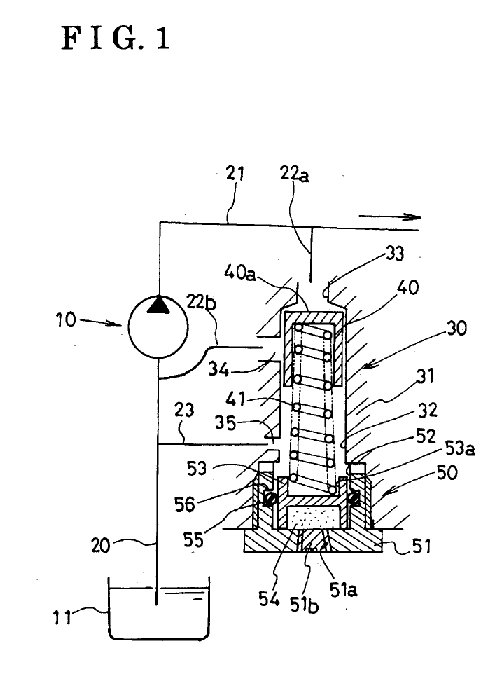

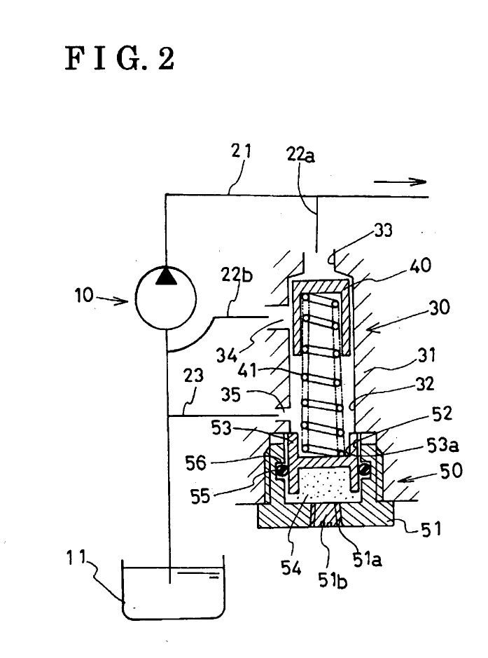

As illustrated in FIGS. 1 and 2, an oil pump 10 according to an embodiment of the present invention is provided with a pump housing (not shown) which houses an inner rotor (not shown) and an outer rotor (not shown). The inner rotor can be driven for rotation by rotational force of a crankshaft. The outer rotor is housed in the pump housing to be rotated in an eccentric way at a predetermined amount relative to the inner rotor. Inner teeth of the outer rotor can be engaged with outer teeth of the inner rotor such that the outer rotor can be rotated in an identical direction with the rotational direction of the inner rotor through the engagement. As described above, the oil pump 10 according to the embodiment of the present invention has a known pump structure. Further, the oil pump 10 pumps fluid, e.g., operating oil, reserved in an oil pan 11 through a suction passage 20, i.e., a first passage and outputs fluid.

The operating oil pressurized by the oil pump 10 is outputted from the oil pump 10 to oil supplied sections through a discharging passage 21, i.e., a second passage. By way of non-limiting examples, the oil supplied sections are represented by a hydraulically driven type actuator of a variable valve timing control system, a lubricated portion such as an engine bearing, a portion cooled down with oil such as a cylinder and a piston, and the like. Further, the operating fluid conveyed to those oil supplied sections can be returned to the oil pan 11 through a drain passage which is not illustrated. There are two relief passages 22a and 22b provided. The relief passage 22a is branched from the discharging passage 21. A relief valve mechanism 30 is provided between the relief passages 22a and 22b. The relief passage 22b is connected to the suction passage 20. Therefore, the oil can flow from the relief passage 22a to the relief passage 22b via the relief valve mechanism 30.

The relief valve mechanism 30 includes a valve body 31 having a hole 32 (i.e. a first hole), and a relief valve 40. The relief valve 40 is positioned in the hole 32 and can be slided in an axial direction of the hole 32. A relief opening 34 (i.e. a first opening) is opened at a portion of an inner peripheral surface of the hole 32. The relief valve 40 has been always biased by a spring 41 in a direction for closing the relief opening 34, i.e. in an upper direction in FIGS. 1 and 2. The valve body 31 further has an oil supply opening 33 at the side of one end of the relief valve 40. When the operating oil is supplied to the one end of the relief valve 40 from the oil pump 10 at a certain pressure level via the oil supply opening 33, the relief valve 40 is slidably moved against the biasing force of the spring 41. In this case, the operating fluid flowing in the oil supply passage 21 can be released via the relief opening 34. Therefore, the pressure of the operating oil supplied to the oil supplied sections can be adjusted to an appropriate pressure level. A drain opening 35 is opened at a portion of the hole 32 at a side of a temperature sensing means 50 which is described later. The drain opening 35 is connected to the suction passage 20 via a drain passage 23 as illustrated in FIGS. 1 and 2 such that the operating oil or air at the side of the spring 41 can be drained along these passages.

The temperature sensing means 50 is positioned downstream with respect to the spring 41, i.e., at an opposite side to the relief valve 40. The temperature sensing means 50 includes a plug 51, i.e., a cylindrical member, a retainer 53, and a thermally adapted material such as a thermal wax 54 as a non-limiting example. The plug 51 fits with the valve body 31 and closes one opening of the hole 32. The retainer 53 is inserted into a hole 52 of the plug 51 so as to be slidably moved therein. The thermal wax 54 is enclosed by the hole 52 and the retainer 53. Further, an o-ring 55 is fit in an annular groove 56 defined at an inner surface of the hole 52 so as to seal a clearance between the hole 52 and the retainer 53. According to this structure, the thermal wax 54 can be maintained at a hermetic condition. The retainer 53 is provided with a recessed portion 53a at a side of the spring 41 so as to hold one end of the spring 41. The plug 51 is provided with a bore 51a for fitting the thermal wax 54 at a position. The bore 51a is hermetically closed by a sealing tap 51b.

As illustrated in FIGS. 1 and 2, the valve body 31 according to the embodiment of the present invention is separated from the oil pump 10. Alternatively, the valve body 31 can be provided integrally with the pump housing (not shown) of the oil pump 10. In this case, the relief passages 22a and 22b can be defined in the pump housing.

The following description describes operation of the relief valve mechanism for the oil pump 10 described above according to the embodiment of the present invention. When the oil pressure generated and outputted by the oil pump 10 reaches a predetermined pressure level, the relief valve 40 is slidably moved against the biasing force of the spring 41 in response to oil pressure applied to a head portion 40a, i.e., the one end of the relief valve 40, via the oil supply opening 33. When the oil pressure then reaches a valve opening pressure level, the relief valve 40 is further moved compressing the spring 41 that had been set with amounting dimensions. The moving direction of the relief valve 40 is opposed to the biasing direction of the spring 41. When the head portion 40a of the relief valve 40 reaches the relief opening 34, the operating oil flows to the suction passage 20 via the relief passage 22a, the hole 32, the relief opening 34, and the relief passage 22b.

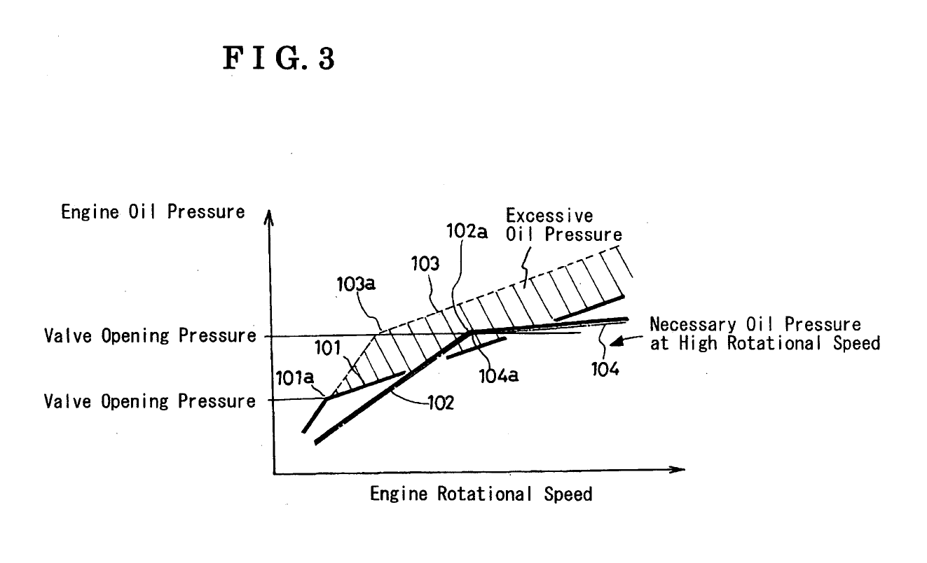

At this point, when the engine has been activated at a normal oil working temperature such as 80 degrees Celsius or around (i.e. a first temperature range), a volume of the thermal wax 54 is reduced due to the oil working temperature. The retainer 53 is then moved downstream towards the plug 51 as illustrated in FIG. 1. In this case, the mounting dimension of the spring 41 is extended. Therefore, when the engine has been activated at such working temperature or around, the valve opening pressure of the relief valve 40 has been designed at a relatively low pressure level. Therefore, as illustrated in FIG. 3, the oil pressure for the engine working in this case can be characterized with an oil pressure characteristic line 101 which is curved at a valve opening pressure 101a.

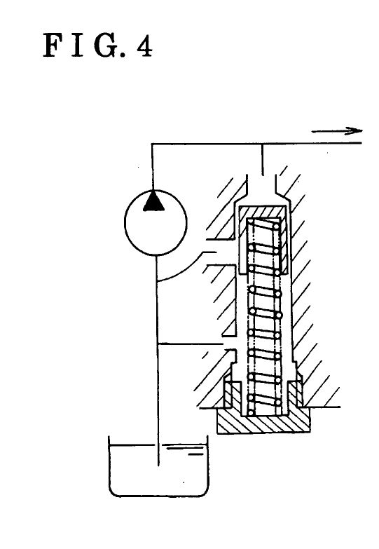

On the other hand, when the relief valve mechanism for the oil pump is not provided with the temperature sensing means 50 as illustrated in FIG. 4, the necessary valve opening pressure of the relief valve 40 can be ensured at the upper threshold oil working temperature such as 130 degrees Celsius. Therefore, when the engine has been activated at the working temperature such as 80 degrees Celsius, the engine oil pressure can be characterized with an oil pressure characteristic broken line 103 that is curved at a valve opening pressure 103a in FIG. 3. As described above, the valve relief mechanism according to the embodiment of the present invention can effectively prevent occurrence of extra oil pressure that is illustrated by a shadow area in FIG. 3. Further, the valve relief mechanism according to the embodiment of the present invention can effectively prevent increase of the driving force of the oil pump and the engine friction torque, and can further prevent extra consuming of the vehicle fuel.

When the engine has been activated at the upper threshold oil working temperature such as 130 degrees Celsius or around (i.e. a second temperature range), the volume of the thermal wax 54 is increased due to the oil working temperature. The retainer 53 then moves up towards the relief valve 40 as illustrated in FIG. 2. In this case, the mounting dimension of the spring 41 is shrunk. Therefore, when the engine has been activated at such a working temperature or around, the valve opening pressure of the relief valve 40 has been designed at a relatively high pressure level. Therefore, as illustrated in FIG. 3, the oil pressure for the engine working in this case can be characterized with an oil pressure characteristic line,102 which is curved at a valve opening pressure 102a.

In the same manner, when the relief valve mechanism for the oil pump is not provided with the temperature sensing means 50 as illustrated in FIG. 4, the necessary valve opening pressure of the relief valve 40 can be ensured at the upper threshold oil working temperature such as 130 degrees Celsius. Therefore, when the engine has been activated at the oil working temperature such as 130 degrees Celsius, the engine oil pressure can be characterized with an oil pressure characteristic dashed line 104 that is curved at a valve opening pressure 104a in FIG. 3. As described above, when the engine has been activated at a relatively high working temperature-i.e., when the crankshaft has been rotated at a relatively high rotational speed, the necessary oil pressure can be ensured by the oil pump according to the embodiment of the present invention in the same manner as the conventional oil pump.

The relief valve mechanism for the oil pump according to the embodiment of the present invention can be applied to any type of oil pump such as a trochoid type pump, a cycloid type pump, and an internal involute type pump as non limiting examples;

Further, the temperature sensing means 50 is positioned at or near the spring 41 at an opposite side to the relief valve 40. Alternatively, the temperature sensing means 50 can be positioned at or near the spring 41 at a side of the relief valve 40. Therefore, the relief valve mechanism according to the embodiment of the present invention can adjust a pressure of an operating oil at a predetermined pressure level with a compact structure and at a relatively low manufacturing cost.

The principles, an embodiment and mode of operation of the present invention have been described in the foregoing specification and drawings. However, the invention which is intended to be protected is not to be construed as limited to the particular embodiment disclosed. Further, the embodiments described herein are to be regarded as illustrative rather than restrictive. Plural objectives are achieved by the present invention, and yet there is usefulness in the present invention as far as one of the objectives are achieved. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A relief valve mechanism for an oil pump comprising;
a body having a first hole;
a spring housed in the body and adapted to apply biasing force to a relief valve in response to contraction of the spring;
a first opening connected to the first hole of the body;
the relief valve adapted to close the first opening in response to the biasing force of the spring and adapted to open the first opening against the biasing force in response to pressure of fluid from the oil pump applied to one end of the valve; and
means for sensing a temperature positioned at the spring.

2. A relief valve mechanism for an oil pump according to claim 1, wherein the means for sensing the temperature is altered in an axial direction of the spring.

3. A relief valve mechanism for an oil pump according to claim 2, wherein the means for sensing the temperature includes a cylindrical member with at least a bottom, a retainer slidably positioned in a second hole of the cylindrical member, and a thermally adapted material enclosed by the retainer and the second hole.

4. A relief valve mechanism for an oil pump according to claim 3, wherein the means for sensing the temperature is positioned at the spring at a side of the valve.

5. A relief valve mechanism for an oil pump according to claim 3, wherein the means for sensing the temperature is positioned at the spring at an opposite side to the valve.

6. A relief valve mechanism for an oil pump according to claim 5, wherein the cylindrical member is a plug adjusted to close the first hole and to avoid dropping of the valve.

7. A relief valve mechanism for an oil pump according to claim 3, wherein the thermally adapted material includes a thermal wax.

8. A method of releasing fluid comprising:
pumping fluid by an oil pump along a first passage;
directing the fluid pumped by the oil pump along a second passage;
releasing at least a portion of the fluid to a valve relief mechanism; and
moving a relief valve of the valve relief mechanism against a biasing force of a spring so as to release at least the portion of the fluid to the first passage.

9. A method of releasing oil according to claim 8, wherein the valve relief mechanism further includes a thermally adapted material adjusted to alter depending on an oil working temperature, a volume of the thermally adapted material is reduced at a first temperature range such that a mounting dimension of the spring is shrunk and a valve opening pressure of the relief valve is at a relatively low pressure level, and the volume of the thermally adapted material is increased at a second temperature range such that the mounting dimension of the spring is extended and the valve opening pressure of the relief valve is at a relatively high pressure level.

10. A method of releasing oil according to claim 9, wherein the thermally adapted material includes a thermal wax.
